(19) United States
(12) Patent Application Publication
(10) Pub. No.: US 2023/0322044 A1
(43) Pub. Date: Oct. 12, 2023

(54) VEHICLE AIR CONDITIONING CONTROL SYSTEM AND METHOD

(71) Applicants: HYUNDAI MOTOR COMPANY, Seoul (KR); KIA CORPORATION, Seoul (KR)

(72) Inventor: Jae Woong Kim, Hwaseong-si (KR)

(21) Appl. No.: 17/978,165

(22) Filed: Oct. 31, 2022

(30) Foreign Application Priority Data
Apr. 12, 2022 (KR) 10-2022-0045348

(51) Int. Cl. B60H 1/00; B60H 1/32

(52) U.S. Cl. CPC B60H 1/00878; B60H 2001/3241; B60H 2001/3261; B60H 1/32

(57) ABSTRACT

Disclosed are a vehicle air conditioning control system and method, the vehicle air conditioning control system including a controller configured to receive a target temperature and a sensor value and determine an optimal control variable on the basis of a cost function that reflects energy consumption and following-up performance in following up the target temperature received by using a control model, and a plant configured to receive the control variable determined by the controller and operate to cool or heat a vehicle interior on the basis of the received control variable.

### CROSS REFERENCE TO RELATED APPLICATION

The present application claims priority to Korean Patent Application No. 10-2022-0045348, filed Apr. 12, 2022, the entire contents of which is incorporated herein for all purposes by this reference.

### BACKGROUND

### Field

The present disclosure relates to a vehicle air conditioning control system and method, and more particularly, to an air conditioning control system and method, which are controlled to follow up a target temperature while optimizing energy consumption.

### Description of the Related Art

Recently, environmental-friendly vehicles such as electric vehicles have come into wide use to solve environmental issues caused by internal combustion engine vehicles. In the case of the internal combustion engine vehicle in the related art, waste heat from an engine may be used to heat the interior, which does not require energy for a separate heating process. However, because the electric vehicle has no engine, i.e., a heat source, separate energy needs to be required to perform the heating process, which causes a deterioration in fuel economy. Further, the deterioration in fuel economy decreases a travelable distance of the electric vehicle and causes the vehicle to require frequent charging, which causes discomfort.

Meanwhile, as the vehicle is motorized, there is an additional need to manage not only heat in the interior of the vehicle, but also heat of electrical components such as a high-voltage battery and a motor. That is, in the case of the electric vehicle, the interior space, the battery, and the electrical components have different needs for air conditioning, and thus there is required a technology capable of maximally saving energy by independently coping with and efficiently and cooperatively managing the different needs. Therefore, an integrated vehicle heat management concept has been proposed in order to improve thermal efficiency by independently managing heat of the respective components and integrating the heat management of the entire vehicle.

In order to perform the integrated vehicle heat management, complicated coolant lines and components need to be integrated and modularized. To this end, a modularization concept capable of modularizing the plurality of components, simply manufacturing the components, and implementing the compact package is needed.

In the related art, a thermal management system and method are controlled by a control method that allows a control temperature (output value) detected by a sensor to follow up a target temperature. However, the above-mentioned method is performed without consideration of energy consumption, which makes it difficult to optimize energy consumption. Further, because the above-mentioned method cannot adopt thermal inertia, the control temperature deviates from the target temperature in some instances.

The foregoing explained as the background is intended merely to aid in the understanding of the background of the present disclosure, and is not intended to mean that the present disclosure falls within the purview of the related art that is already known to those skilled in the art.

### SUMMARY

The present disclosure is proposed to solve these problems and aims to provide a technology that applies an optimum control algorithm using model-based predictive (MPC) control to air conditioning of a vehicle interior.

To achieve the above-mentioned objects, the present disclosure provides a vehicle air conditioning control system including a controller configured to receive a target temperature and a sensor value and determine an optimal control variable on the basis of a cost function that reflects energy consumption and following-up performance in following up the target temperature received by using a control model, and a plant configured to receive the control variable determined by the controller and operate to cool or heat a vehicle interior on the basis of the received control variable.

The control variable determined by the controller may be a physical quantity that affects a process of cooling or heating the vehicle interior depending on a result of operating the plant.

The plant may be a compressor configured to compress and discharge an introduced refrigerant or a cooling fan configured to allow air to flow around a condenser, and the controller may determine the control variable that allows a flow rate of the refrigerant flowing to the condenser or a flow rate of air flowing around the condenser to satisfy a constraint condition related to an operating range of a preset refrigerant cycle.

The plant may be a compressor configured to compress and discharge an introduced refrigerant, and the controller may determine the control variable that satisfies a constraint condition related to a flow rate of the refrigerant according to a highest rotational velocity or a lowest rotational velocity of the compressor.

The plant may be a compressor configured to compress and discharge an introduced refrigerant or a cooling fan configured to allow air to flow around a condenser, and the cost function may reflect power consumption of the compressor or power consumption of the cooling fan.

The cost function may reflect an error between a target temperature and an indoor air temperature of a vehicle or a temperature of air discharged from an evaporator.

To achieve the above-mentioned object, the present disclosure provides a vehicle air conditioning control method including receiving a target temperature and a sensor value, determining an optimal control variable on the basis of a cost function that reflects energy consumption and following-up performance in following up the target temperature received by using a control model, and operating a plant to cool or heat a vehicle interior on the basis of the determined control variable.

The control variable may be a physical quantity that affects a process of cooling or heating the vehicle interior depending on a result of operating the plant.

The plant may be a compressor configured to compress and discharge an introduced refrigerant or a cooling fan configured to allow air to flow around a condenser, and the determining of the optimal control variable may include determining the control variable that allows a flow rate of the refrigerant flowing to the condenser or a flow rate of air flowing around the condenser to satisfy a constraint condition related to an operating range of a preset refrigerant cycle.

The plant may be a compressor configured to compress and discharge an introduced refrigerant, and the determining of the optimal control variable may include determining the control variable that satisfies a constraint condition related to a flow rate of the refrigerant according to a highest rotational velocity or a lowest rotational velocity of the compressor.

The plant may be a compressor configured to compress and discharge an introduced refrigerant or a cooling fan configured to allow air to flow around a condenser, and in the determining of the optimal control variable, the cost function may reflect power consumption of the compressor or power consumption of the cooling fan.

In the determining of the optimal control variable, the cost function may reflect an error between a target temperature and an indoor air temperature of a vehicle or a temperature of air discharged from an evaporator.

According to the vehicle air conditioning control system and method according to the present disclosure, it is possible to improve following-up control performance in allowing the temperature of the vehicle interior to follow up the target temperature. Further, it is possible to reduce energy consumption required to heat/cool the vehicle.

### BRIEF DESCRIPTION OF THE DRAWINGS

FIG. 1 is a configuration view of a vehicle air conditioning control system according to an embodiment of the present disclosure.

FIG. 2 is a configuration view of a thermal system model for a cabin according to the embodiment of the present disclosure.

FIG. 3 is a P-h diagram of a refrigerant cycle according to the embodiment of the present disclosure.

FIG. 4 is a view illustrating enthalpies of saturated gas and saturated liquid assumed in the present disclosure.

FIG. 5 is a view illustrating enthalpies of saturated gas and saturated liquid assumed in the present disclosure.

FIG. 6 is a graph illustrating behavior related to a refrigerant mass flow rate and an air mass flow rate according to the embodiment of the present disclosure.

FIG. 7 is a graph illustrating behavior related to a refrigerant mass flow rate and a temperature of a refrigerant according to the embodiment of the present disclosure.

FIG. 8 is a flowchart illustrating a vehicle air conditioning control method according to the embodiment of the present disclosure.

### DETAILED DESCRIPTION

Specific structural or functional descriptions of embodiments of the present disclosure disclosed in this specification or application are exemplified only for the purpose of explaining the embodiments according to the present disclosure, the embodiments according to the present disclosure may be carried out in various forms, and it should not be interpreted that the present disclosure is limited to the embodiments described in this specification or application.

Because the embodiments according to the present disclosure may be variously changed and may have various forms, specific embodiments will be illustrated in the drawings and described in detail in the present specification or application. However, the descriptions of the specific embodiments are not intended to limit embodiments according to the concept of the present disclosure to the specific embodiments, but it should be understood that the present disclosure covers all modifications, equivalents and alternatives falling within the spirit and technical scope of the present disclosure.

The terms such as “first” and/or “second” may be used to describe various constituent elements, but these constituent elements should not be limited by these terms. These terms are used only for the purpose of distinguishing one constituent element from other constituent elements. For example, without departing from the scope according to the concept of the present disclosure, the first constituent element may be referred to as the second constituent element, and similarly, the second constituent element may also be referred to as the first constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

The terms used in the present specification are used to just describe a specific embodiment and do not intend to limit the present disclosure. Singular expressions include plural expressions unless clearly described as different meanings in the context. In the present specification, it should be understood the terms “comprises,” “comprising,” “includes,” “including,” “containing,” “has,” “having” or other variations thereof are inclusive and therefore specify the presence of stated features, numbers, steps, operations, elements, components, or combinations thereof, but do not preclude the presence or addition of one or more other features, numbers, steps, operations, elements, components, or combinations thereof.

Unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present specification.

Hereinafter, the present disclosure will be described in detail through description of preferred embodiments of the present disclosure with reference to the accompanying drawings. Like reference numerals indicated in the respective drawings refer to like members.

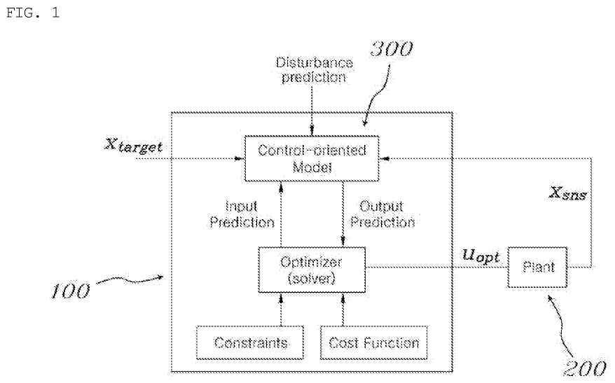

FIG. 1 is a configuration view of a vehicle air conditioning control system according to an embodiment of the present disclosure.

Referring to FIG. 1, the vehicle air conditioning control system according to the embodiment of the present disclosure includes a controller 100 configured to receive a target temperature and determine an optimal control variable on the basis of a cost function that reflects energy consumption and performance in following up the target temperature received by using a control model 300, and a plant 200 configured to receive the control variable determined by the controller 100 and operate to heat or cool a vehicle interior based on the received control variable.

The vehicle air conditioning control system includes components such as a compressor, a condenser, an expansion valve, and an evaporator. Additionally, the vehicle air conditioning control system may further include a cooling fan configured to circulate air around the condenser, a blower configured to allow air to flow around the evaporator, an inside/outside air door configured to introduce outside air, a heater (e.g., a PTC heater) configured to heat air having passed through the evaporator, and a temperature door configured to adjust an air flow rate toward the electric heater.

The controller 100 according to an exemplary embodiment of the present disclosure may be implemented by a non-volatile memory (not illustrated) configured to algorithm for controlling operations of various constituent elements in a vehicle or store data related to software commands for executing the algorithm, and by a processor (not illustrated) configured to perform the following operations by using the data stored in the corresponding memory. In this case, the memory and the processor may be implemented as separate chips. Alternatively, the memory and the processor may be implemented as a single chip in which the memory and the processor are integrated. The processor may be configured in the form of one or more processors.

In particular, the controller 100 according to the embodiment of the present disclosure may be an integrated thermal management controller 100 configured to simultaneously control a compressor configured to compress a refrigerant, a cooling fan configured to generate an air flow in an external condenser, a PTC heater disposed in an air conditioning line, a blower configured to allow air to flow in the air conditioning line, an expansion valve, and a flow adjustment valve.

As described below, the controller 100 may reflect a cost function and a constraint condition to an MPC control algorithm when controlling the plant 200 so that the plant 200 follows up the target temperature by using the control model.

In addition, the plant 200 according to the embodiment of the present disclosure is a control target that the controller 100 controls. The controller 100 may control the inputted control variable (u) for the plant 200 so that an output value (x_sns) of the plant 200 sensed by a sensor becomes a target value (x_target).

In one embodiment, the plant 200 is described as the compressor and the cooling fan, for example. In addition, the plant 200 may be an apparatus for optimally controlling a chiller connected to and configured to exchange heat with a cooling line for cooling an active air flap (AAF) and a battery.

Air conditioning control in the related art controls a control variable (u) that follows up a target value (temperature) regardless of energy consumption. In particular, in a case in which an open-loop control method is used, the method cannot adopt thermal inertia. For this reason, the temperature deviates from the target value, and it is difficult to optimize energy consumption.

The controller 100 according to the present disclosure uses model-based predictive control (MPC) and outputs a control variable (u0) at the current point in time that minimizes a cost function that reflects energy consumption and following-up performance in a time window including the current point in time and the distant future. At the next point in time, the controller 100 repeats calculation in a new time window and sets an optimal control variable.

The control variable determined by the controller 100 according to the present disclosure may be a physical quantity that has an effect on a process of heating or cooling the vehicle interior depending on a result of operating the plant 200.

Specifically, in the air conditioning control system for thermal management, the amount of operation of the plant 200 (e.g., a rotational speed of the compressor, a rotational speed of the cooling fan, etc.) shows non-linear behavior with respect to thermal physical property values (e.g., a refrigerant flow rate, an air flow rate, etc.) which are actual components for substantial control.

Therefore, in the present disclosure, the thermal physical property value, which is the actual component for control, may be set to the control variable. Specifically, the control variable may be a mass flow rate of the refrigerant flowing to the condenser or a mass flow rate of air flowing around the condenser.

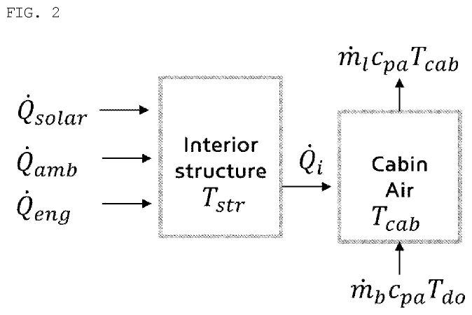

FIG. 2 is a configuration view of a thermal system model according to the embodiment of the present disclosure.

Referring further to FIG. 2, a thermal system model for vehicle interior air conditioning control is made in consideration of heat transfer from an engine and an internal component, solar heat, external heat transfer, ventilation thermal loss, and the like. In a vehicle interior, an interior material temperature and an indoor air temperature are changed by being affected by outside air, solar radiation, engine heat, and the like. Because the interior material temperature and the indoor air temperature are not uniform, the analysis for mimicking the actual behavior provides several sections. However, a lumped capacity method is adopted to be used for the control model. An actual indoor temperature sensor is disposed adjacent to a driver seat at a front side of the vehicle, and the analysis only needs to mimic the indoor temperature sensor. Further, the interior material has various temperature distributions depending on material physical properties and a degree to which the interior material is exposed to the solar radiation, and there is no sensor. Therefore, the interior material temperature is set to an imaginary model temperature.

In one embodiment, a vehicle interior temperature (T_cab) and an interior material temperature (T_str) may be calculated on the basis of the following equations.

$$\frac{{dT}_{cab}}{dt} = \frac{1}{{m}_{cab} {c}_{p , cab}} ( {m}_{b} {c}_{pa} ( {T}_{a , da} - {T}_{cab} ) + {hA}_{i} ( {T}_{str} - {T}_{cab} ) )$$

$$\frac{{dT}_{str}}{dt} = \frac{1}{{m}_{str} {c}_{p , str}} ( α {\dot{Q}}_{solar} + {hA}_{o} ( {T}_{amb} - {T}_{str} ) - h \text{?} ( {T}_{str} - {T}_{cab} ) + {\dot{Q}}_{eng} - {\dot{Q}}_{leak} )$$

$$\text{?} \text{indicates text missing or illegible when filed}$$

Here, m_{cab} represents mass of vehicle indoor air, \dot{m}_{b} represents a mass flow rate of air introduced into the interior by the blower, cₚₐ represents specific heat of air introduced into the interior through the air conditioning line, c_{p,cab} represents specific heat of vehicle indoor air, T_{a,do} represents a temperature of air introduced into the interior through the air conditioning line, a represents heat transmittance (0<a<1), \dot{Q}ₛₒₗₐᵣ represents the amount of heat transferred from the sun to the vehicle, \dot{Q}_{eng} represents the amount of heat transferred from the engine to the vehicle interior, and \dot{Q}ₗₑₐₖ represents a loss of heat because of ventilation.

In addition, a heat transfer coefficient implemented by convection may be defined as follows. The heat transfer may be defined on the basis of an analysis model or actual vehicle evaluation.

hAᵢ=f(\dot{m}_{b})

hAₒ=f(V_{spd})

Here, V_{spd} represents a velocity of the vehicle.

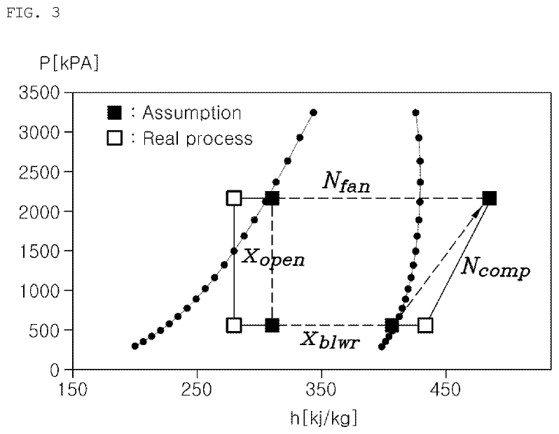

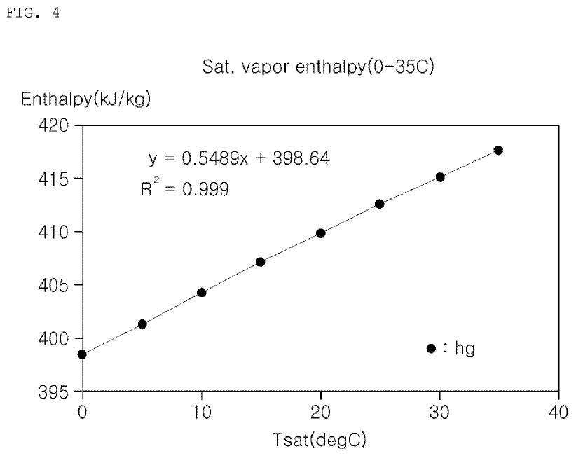

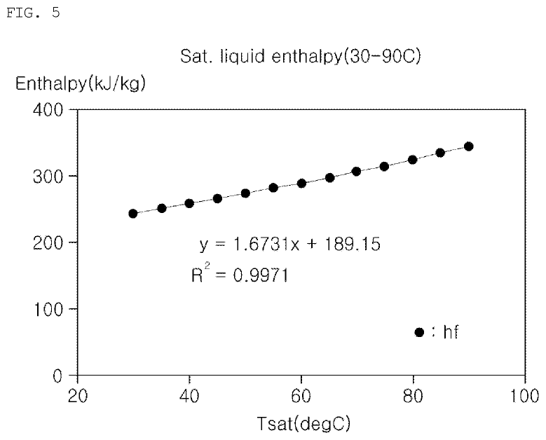

FIG. 3 is a P-h diagram of a refrigerant cycle according to the embodiment of the present disclosure, and FIGS. 4 to 5 are views illustrating enthalpies of saturated gas and saturated liquid assumed in the present disclosure.

Specifically, referring further to FIGS. 3 to 5, in the vehicle air conditioning system, the compressor discharges a high-temperature/high-pressure gaseous refrigerant, the condenser cools the refrigerant to produce a low-temperature/high-pressure liquid refrigerant, and the expansion valve generates a low-temperature/low-pressure two-phase refrigerant that may be easily evaporated. Finally, the refrigerant absorbs heat from ambient air while passing through the evaporator and is converted into a high-temperature/low-pressure gaseous refrigerant, and then the refrigerant flows into the compressor again. As described above, the air conditioning control system defines the refrigeration cycle, dries the vehicle interior, and supplies cold air.

In particular, the behavior of the refrigerant may be expressed as a Mollier diagram (P-h) illustrated in FIG. 3. The actual behavior (real process) is very difficult to use as the control model. Therefore, the present state may be assumed as a quasi-steady state, and the states of the refrigerant passing through the condenser and the evaporator may be assumed as saturated liquid and saturated gas, respectively. Therefore, the state of the refrigerant is simply determined as a single state value (e.g., a temperature, a pressure, a physical property value, etc.). As illustrated in FIGS. 4 to 5, the enthalpies of the saturated gas and the saturated liquid may be expressed only by temperature functions.

The follow state equation may be defined to control a temperature (T_{a,eo}) of air discharged from the evaporator. In this case, the state equation is based on the energy equation showing that the amount of change in heat of the refrigerant is equal to the amount of change in sensible heat of air and the amount of change in latent heat of air. The control element is [\dot{m}_{comp} \dot{m}_{fan}].

$${T}_{a , eo} = {T}_{a , bo} + \frac{{\dot{m}}_{comp} ( {h}_{e , in} - {h}_{e , out} ) + {\dot{m}}_{b} ( {ω}_{1} - {ω}_{2} ) {h}_{fg}}{{\dot{m}}_{b} {c}_{pa}}$$

T_{a,bo} represents a temperature of air discharged from the blower, \dot{m}_{comp} represents a mass flow rate of the refrigerant, h_{e,in} and h_{e,out} represent enthalpies of the refrigerant introduced into or discharged from the compressor, \dot{m}_{b} represents a mass flow rate of air introduced into the vehicle interior by the blower, ω₁ and ω₂ represent absolute humidities at an inlet and an outlet of the evaporator, h_{fg} represents condensation heat with respect to latent heat of moist air, and cₚₐ represents specific heat of air.

In this case, the dynamic behavior may be primarily treated by a filter and expressed to express a reaction delay of the temperature of the air discharged from the evaporator.

$$\frac{{dT}_{a , eof}}{dt} = - \frac{1}{τ} {T}_{a , eof} + \frac{1}{τ} {T}_{a , eo}$$

Here, τ represents a time constant.

In h_{e,in}−h_{e,out}, Δhₑ is affected by the refrigerant mass flow rate, the air mass flow rate, and the outside air temperature, as shown in the following equations. In this manner, the control model equation related to the behavior in respect to the temperature of air discharged from the evaporator in the air conditioner cycle is defined.

Δhₑ=h_{e,in}−h_{e,out}≈f(\dot{m}_{comp}, \dot{m}_{fan}, T_{amb})

Therefore, the behavior of the air conditioning system is expressed by the following equation related to the temperature of air discharged from the evaporator.

$${dT}_{α , eo} / dt = - \frac{{T}_{α , eo}}{τ} + \frac{1}{τ} ( {γ}_{intake} {T}_{cab} + ( 1 - {γ}_{intake} ) {T}_{amb} + \frac{{\dot{m}}_{comp} Δ {h}_{e}}{{\dot{m}}_{b} {C}_{pa , e}} + \frac{( {w}_{1} - {w}_{2} ) {h}_{fg}}{{C}_{pa , e}} )$$

$${h}_{fg} = - 2.364 \text{?} + 2501.4$$

$$\text{?} \text{indicates text missing or illegible when filed}$$

Here, T_{amb} represents an outside air temperature, and γᵢₙₜₐₖₑ represents an air circulation ratio (a ratio of a flow rate of inside air to an air flow rate of the blower).

A heat transfer rate in the condenser is as follows.

\dot{Q}_{c}=ε_{c}\dot{m}_{fan}cₚₐ(T_{r,c}−T_{amb})

Here, ε_{c} represents heat transfer effectiveness of the condenser, and T_{r,c} represents a refrigerant temperature in the condenser.

Therefore, the amount of change in enthalpy in the evaporator may be expressed by the following equation.

Δhₑ=hₑᵢ−hₑₒ=1.6731T_{r,c}+189.15−0.5489T_{r,e}−398.64≅f(\dot{m}_{comp}, \dot{m}_{fan}, T_{amb})˜f(\dot{m}_{comp}, \dot{m}_{fan})*K_{corr}

In sum, the dynamic equations of the control model in the air conditioning system are organized by the following three equations.

$$\frac{{dT}_{cab}}{dt} = \frac{1}{{m}_{cab} {c}_{p , cab}} ( {\dot{m}}_{b} {c}_{pa} ( {T}_{a , do} - {T}_{cab} ) + {hA}_{i} ( {T}_{str} - {T}_{cab} ) ) \qquad ( 1 )$$

$$\frac{{dT}_{str}}{dt} = \frac{1}{{m}_{str} {c}_{p , str}} ( α {\dot{Q}}_{solar} + {hA}_{o} ( {T}_{amb} - {T}_{str} ) - {hA}_{i} ( {T}_{str} - {T}_{cab} ) + {\dot{Q}}_{eng} - {\dot{Q}}_{leak} ) \qquad ( 2 )$$

$${dT}_{a , eo} / dt = - \frac{{T}_{a , eo}}{τ} + \frac{1}{τ} ( {γ}_{intake} {T}_{cab} + ( 1 - {γ}_{intake} ) {T}_{amb} + \frac{{\dot{m}}_{comp} Δ {h}_{e}}{{\dot{m}}_{b} {C}_{pa , e}} + \frac{( {w}_{1} - {w}_{2} ) {h}_{fg}}{{C}_{pa , e}} ) \qquad ( 3 )$$

Here, as described below, state temperatures (x) may be an indoor air temperature (T_{cab}) of the vehicle, an interior material temperature (Tₛₜᵣ), and a temperature (Tₐₑₒ) of air discharged from the evaporator.

x=[T_{cab} Tₛₜᵣ Tₐₑₒ]^{T}

In addition, as described above, the control variables (u) may be a mass flow rate (\dot{m}_{comp}) of the refrigerant, a mass flow rate (\dot{m}_{fan}) of air, and the amount of heat generation (Pₕₜᵣ) of the heater.

u=[\dot{m}_{comp} \dot{m}_{fan} Pₕₜᵣ]^{T}

The following static state equations are additionally used.

$${T}_{a , bo} = {γ}_{intake} {T}_{cab} + ( 1 - {γ}_{intake} ) {T}_{amb} \\ {T}_{r , eo} = {T}_{a , bo} - \frac{1}{{ε}_{e}} ( {T}_{a , bo} - {T}_{a , eo} ) \\ {T}_{a , do} = {T}_{a , eo} + {P}_{htr} / ( {\dot{m}}_{blwr} {C}_{pa} ) \\ {h}_{fg} ≅ - 2.364 * {T}_{aeo} + 2501.4 kJ / kg \\ {ε}_{c} = f ( {\dot{m}}_{fan} ) \\ {ε}_{e} = f ( {\dot{m}}_{blwr} ) \\ {w}_{1} = {w}_{amb} ( 1 - {γ}_{intake} ) + {w}_{cabin} {γ}_{intake} \\ {w}_{2} = f ( {T}_{aeo} , {P}_{atm} )$$

Here, T_{a,bo} represents a temperature of air discharged from the blower, T_{r,eo} represents a temperature of the refrigerant at the outlet of the evaporator, \dot{m}_{blwr} represents a mass flow rate of air flowing in the blower, w₁ and w₂ represent absolute humidities at the inlet and the outlet of the evaporator, and w_{amb} and w_{cabin} represent absolute humidities in the atmosphere and the vehicle interior.

More specifically, the temperature of air discharged from the evaporator and the indoor air temperature are determined on the basis of various inputs of the compressor, the cooling fan, the PTC heater, and the like in a multi-input/multi-output (MIMO) system. A control variable (u=[\dot{m}_{comp} \dot{m}_{fan} Pₕₜᵣ]^{T}), which satisfies the dynamic equation, includes innumerable combinations, but the control value may not actually satisfy the refrigerant cycle. This is because the temperature may be determined at an unintended position out of the operating range even though energy balance for each system of the air conditioner cycle is considered in the control model equation. Therefore, the operating range of the control variable (u) may be restricted as follows.

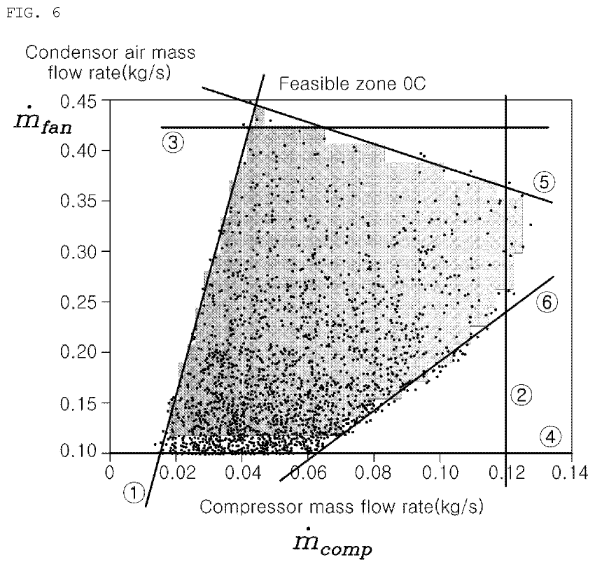

FIG. 6 is a graph illustrating behavior related to a refrigerant mass flow rate and an air mass flow rate according to the embodiment of the present disclosure.

Referring further to FIG. 6, the plant 200 is the compressor configured to compress and discharge the introduced refrigerant or the vehicle velocity effect and the cooling fan configured to allow the air to flow around the condenser, and the controller 100 may determine a control variable that allows a flow rate of the refrigerant flowing to the condenser or a flow rate of the air flowing around the condenser to satisfy a constraint condition related to the operating range of the preset refrigerant cycle.

In one embodiment, the constraint condition related to the behavior in the compressor and the condenser may be set as described below. In particular, the refrigerant mass flow rate and the air mass flow rate may be restricted by the following expression. In this case, a₁, a₂, and a₃ may be set depending on the outside air temperature and determined by experiments.

a₁\dot{m}_{fan}+a₂\dot{m}_{comp}+a₃≤0

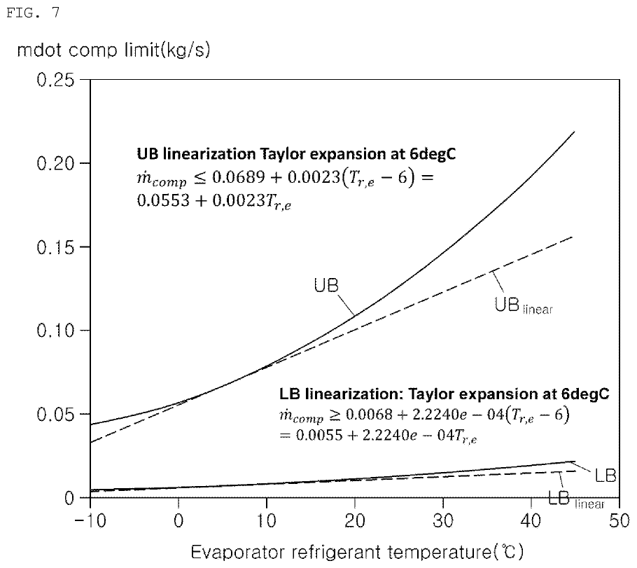

FIG. 7 is a graph illustrating behavior related to the refrigerant mass flow rate and the temperature of the refrigerant according to the embodiment of the present disclosure.

Referring further to FIG. 7, in another embodiment, the plant 200 is the compressor configured to compress and discharge the introduced refrigerant, and the controller 100 may determine a control variable that satisfies a constraint condition related to a flow rate of the refrigerant according to a highest rotational velocity or a lowest rotational velocity of the compressor.

Specifically, the constraint condition related to the operation of the compressor may be set as described below.

\dot{m}_{comp}=f(Pr, T_{r,in})⇒a₁\dot{m}_{comp}+a₂T_{r,in}≤a₃

a1, a2, and a3 may be set by experiments depending on the temperature of the refrigerant to be introduced into the compressor.

More specifically, conditions related to a maximum rotational velocity and a minimum rotational velocity of the compressor are extracted, and a constraint condition may be set so that the compressor operates between the maximum rotational velocity and the minimum rotational velocity.

Variously deployed formulas may be used as cost functions. In particular, the cost function may reflect energy consumption and following-up performance (tracking errors) from the present point in time to any future time. That is, the cost function may reflect power consumption of the compressor or the power consumption of the cooling fan. Further, the cost function may reflect an error between a target temperature and the indoor air temperature of the vehicle or the temperature of air discharged from the evaporator.

$$J = {\sum }_{k = 0}^{k = N - 1} ( {\underbrace{\frac{1}{2} {W}_{cab} {T}_{{cab}_{err} , k}^{2} + \frac{1}{2} {W}_{aeo} {T}_{{aeo}_{err} , k}^{2}}}_{penalty on tracking error} + {\underbrace{{P}_{comp , k} + {P}_{fan , k} + {P}_{htr , k}}}_{\begin{matrix}penalty on actuation : \\ consumption power\end{matrix}} )$$

Specifically, the cost function may reflect an error (T_{cab}_{ₑᵣᵣ}_{,k}) between the target temperature and the indoor air temperature of the vehicle and an error (Tₐₑₒ_{ₑᵣᵣ}_{,k}) between the target temperature and the temperature of air discharged from the evaporator in order to reflect the following-up performance.

In addition, the plant 200 is the compressor configured to compress and discharge the introduced refrigerant or the cooling fan configured to allow air to flow around the condenser, and the cost function may reflect power consumption of the compressor or power consumption of the cooling fan.

Specifically, the power consumption of the compressor may be expressed by the following equations.

$${P}_{comp} = {P}_{flow} / {η}_{k} \\ {P}_{flow} = \frac{N}{60} {P}_{in} V ( \frac{n}{n - 1} ) ( {( \frac{{P}_{out}}{{P}_{in}} )}^{\frac{n - 1}{n}} - 1 )$$

ηₖ represents operational efficiency of the compressor, Pᵢₙ and Pₒᵤₜ represent refrigerant pressures at the inlet and the outlet of the compressor, V represents a volume of the refrigerant, n represents a compression ratio, and N represents a rotational velocity of the compressor.

The power consumption of the compressor is a complicated factor that varies depending on the state of the refrigerant, entropy efficiency, and the like. The power consumption of the compressor is expressed by the following equation including the control variable (u).

P_{comp}=f(\dot{m}_{comp}, \dot{m}_{fan}, T_{r,e}, T_{amb})

Here, a temperature (T_{r,e}) of the refrigerant in the evaporator may be expressed by the following equation.

$${T}_{r , e} = {T}_{a , bo} - \frac{1}{{ε}_{e}} ( {T}_{a , bo} - {T}_{a , eof} )$$

T_{a,bo} represents a temperature of air at a side of an outlet of the blower, and T_{a,eof} represents a temperature of air at a side of the outlet of the evaporator.

In addition, the power consumption of the cooling fan may be expressed as a traveling velocity of the vehicle and a mass flow rate of air flowing around the condenser as shown in the following equation.

P_{fan}=f(\dot{m}_{fan}, V_{spd})

\dot{m}_{fan,k} represents a mass flow rate of air flowing through the cooling fan, and V′_{spd,k} represents a traveling velocity of the vehicle.

In addition, the amount of heat generation of the heater may be electric power consumed by the PTC heater in the air conditioning line.

P_{heater,k}(W)=Q_{heater,k}

In particular, the air conditioning control system may be a linear time varying system (LTV) model in which parameter matrices A and B are changed for each time even though the parameter matrices A and B are linearized at the operating point as described below.

$$\dot{x} ( t ) = f ( x ( t ) , u ( t ) ) \\ \dot{x} \sim f ( {x}_{0} , {u}_{0} ) + \frac{\partial f}{\partial x} ( x - {x}_{0} ) + \frac{\partial f}{\partial u} ( u - {u}_{0} ) \\ {x}_{k + 1} = {A}_{k} {x}_{k} + {B}_{k} {u}_{k}$$

Referring further to FIG. 1, the controller 100 calculates an optimal control variable (u) for Horizon which is a predetermined future from the current point in time. In particular, the linearization is performed for each moment in Horizon, thereby obtaining discrete equations.

x((k+1)Tₛ)=A_{d}x(kTₛ)+B_{d}u(kTₛ)

xₖ₊₁=A_{d}xₖ+B_{d}uₖ

The control input from the current point in time to the predetermined future may be defined again as follows.

U=[u₀ u₁ . . . uₖ₋₁]^{T}

The cost function J may be expressed in the form of a quadratic equation in respect to a control input by using the defined U.

$$J = \frac{1}{2} {U}^{T} HU + {f}^{T} U$$

In addition, the constraint condition may be expressed as follows.

GU≤W

When the cost function made in consideration of the constraint condition is solved, the optimal control input from the current point in time to the predetermined future is obtained.

In this case, u₀, which is a control input at the current point in time, is performed.

Considering that the control input is a physical quantity, the physical quantity may be changed to the amount of operation by the following equations in order to finally operate the compressor or the cooling fan.

N_{comp}=f(\dot{m}_{comp}, T_{r,e}, T_{r,c})

N_{fan}=f(\dot{m}_{fan}, V_{spd})

T_{r,e} represents an evaporator side refrigerant saturation temperature, and T_{r,c} represents a condenser side refrigerant saturation temperature. It is possible to express the compression ratio of the refrigerant by using the evaporator side refrigerant saturation temperature and the condenser side refrigerant saturation temperature.

Therefore, the control model 300 is efficiently used in comparison with the controls in the related art, thereby reducing energy consumption while improving following-up performance. In addition, feedforward control and sensor value feedback control are simultaneously applied, which makes it possible to control the response velocity in advance and compensate for inaccuracy of the control model.

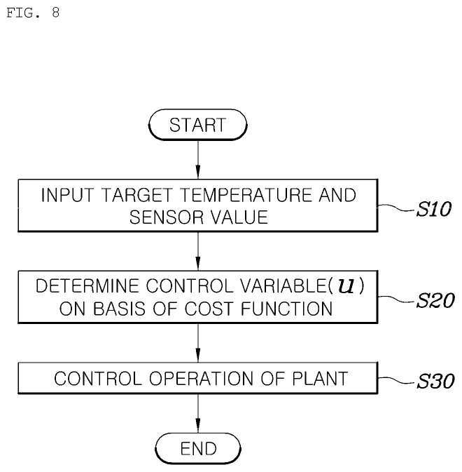

FIG. 8 is a flowchart illustrating a vehicle air conditioning control method according to the embodiment of the present disclosure.

Referring further to FIG. 8, the vehicle air conditioning control method according to the embodiment of the present disclosure includes: receiving (S10) a target temperature and a sensor value of the plant; determining (S20) an optimal control variable on the basis of the cost function that reflects energy consumption and following-up performance that follows up a target temperature received by using the control model; operating (S30) the plant 200 to heat or cool the vehicle interior on the basis of the determined control variable.

The control variable may be a physical quantity that affects a process of heating or cooling the vehicle interior depending on a result of operating the plant 200.

The plant 200 is the compressor configured to compress and discharge the introduced refrigerant or the cooling fan configured to allow the air to flow around the condenser, and the determining (S20) of the optimal control variable may include determining a control variable that allows a flow rate of the refrigerant flowing to the condenser or a flow rate of the air flowing around the condenser to satisfy a constraint condition related to the operating range of the preset refrigerant cycle.

The plant 200 is the compressor configured to compress and discharge the introduced refrigerant, and the determining (S20) of the optimal control variable may include determining a control variable that satisfies a constraint condition related to a flow rate of the refrigerant according to a highest rotational velocity or a lowest rotational velocity of the compressor.

The plant 200 is the compressor configured to compress and discharge the introduced refrigerant or the cooling fan configured to allow air to flow around the condenser, and in the determining (S20) of the optimal control variable, the cost function may reflect power consumption of the compressor or power consumption of the cooling fan.

In the determining (S20) of the optimal control variable, the cost function may reflect an error between a target temperature and the indoor air temperature of the vehicle or the temperature of air discharged from the evaporator.

While the specific embodiments of the present disclosure have been illustrated and described, it will be obvious to those skilled in the art that the present disclosure may be variously modified and changed without departing from the technical spirit of the present disclosure defined in the appended claims.

What is claimed is:

1. A vehicle air conditioning control system comprising:
a controller configured to receive a target temperature and a sensor value and determine an optimal control variable on the basis of a cost function that reflects energy consumption and following-up performance in following up the target temperature received by using a control model; and
a plant configured to receive the control variable determined by the controller and operate to cool or heat a vehicle interior on the basis of the received control variable.

2. The vehicle air conditioning control system of claim 1, wherein the control variable determined by the controller is a physical quantity that affects a process of cooling or heating the vehicle interior depending on a result of operating the plant.

3. The vehicle air conditioning control system of claim 1, wherein the plant is a compressor configured to compress and discharge an introduced refrigerant or a cooling fan configured to allow air to flow around a condenser, and the controller determines the control variable that allows a flow rate of the refrigerant flowing to the condenser or a flow rate of air flowing around the condenser to satisfy a constraint condition related to an operating range of a preset refrigerant cycle.

4. The vehicle air conditioning control system of claim 1, wherein the plant is a compressor configured to compress and discharge an introduced refrigerant, and the controller determines the control variable that satisfies a constraint condition related to a flow rate of the refrigerant according to a highest rotational velocity or a lowest rotational velocity of the compressor.

5. The vehicle air conditioning control system of claim 1, wherein the plant is a compressor configured to compress and discharge an introduced refrigerant or a cooling fan configured to allow air to flow around a condenser, and the cost function reflects power consumption of the compressor or power consumption of the cooling fan.

6. The vehicle air conditioning control system of claim 1, wherein the cost function reflects an error between a target temperature and an indoor air temperature of a vehicle or a temperature of air discharged from an evaporator.

7. The vehicle air conditioning control system of claim 1, wherein the cost function considers cost from the current point in time to a predetermined future.

8. A vehicle air conditioning control method comprising:
receiving a target temperature and a sensor value;
determining an optimal control variable on the basis of a cost function that reflects energy consumption and following-up performance in following up the target temperature received by using a control model; and
operating a plant to cool or heat a vehicle interior on the basis of the determined control variable.

9. The vehicle air conditioning control method of claim 8, wherein the control variable is a physical quantity that affects a process of cooling or heating the vehicle interior depending on a result of operating the plant.

10. The vehicle air conditioning control method of claim 8, wherein the plant is a compressor configured to compress and discharge an introduced refrigerant or a cooling fan configured to allow air to flow around a condenser, and the determining of the optimal control variable includes determining the control variable that allows a flow rate of the refrigerant flowing to the condenser or a flow rate of air flowing around the condenser to satisfy a constraint condition related to an operating range of a preset refrigerant cycle.

11. The vehicle air conditioning control method of claim 8, wherein the plant is a compressor configured to compress and discharge an introduced refrigerant, and the determining of the optimal control variable comprises determining the control variable that satisfies a constraint condition related to a flow rate of the refrigerant according to a highest rotational velocity or a lowest rotational velocity of the compressor.

12. The vehicle air conditioning control method of claim 8, wherein the plant is a compressor configured to compress and discharge an introduced refrigerant or a cooling fan configured to allow air to flow around a condenser, and in the determining of the optimal control variable, the cost function reflects power consumption of the compressor or power consumption of the cooling fan.

13. The vehicle air conditioning control method of claim 8, wherein in the determining of the optimal control variable, the cost function reflects an error between a target temperature and an indoor air temperature of a vehicle or a temperature of air discharged from an evaporator.
